(19) United States
(12) Patent Application Publication
(10) Pub. No.: US 2026/0120258 A1
(43) Pub. Date: Apr. 30, 2026

(54) HIGH-DYNAMIC RANGE CONTENT CREATION, TRANSMISSION, AND RENDERING WITH DYNAMIC COLOR METADATA

(71) Applicant: SAMSUNG ELECTRONICS CO., LTD., Gyeonggi-Do (KR)

(72) Inventors: Chang Su, Foothill Ranch, CA (US); Chenguang Liu, Tustin, CA (US)

(21) Appl. No.: 19/272,321

(22) Filed: Jul. 17, 2025

Related U.S. Application Data
(60) Provisional application No. 63/713,235, filed on Oct. 29, 2024.

(51) Int. Cl. G06T 5/92; G06T 5/40

(52) U.S. Cl. CPC G06T 5/92; G06T 5/40; G06T 2207/10024; G06T 2207/20208

(57) ABSTRACT

High-dynamic range (HDR) content creation, transmission, and rendering with dynamic color metadata includes separating chroma data from luma data of HDR content. The HDR content includes a plurality of segments. Dynamic color data is generated from the chroma data. The dynamic color metadata is generated for each segment of the plurality of segments of the HDR content. The dynamic color metadata specifies hue and saturation data for the HDR content on a per segment basis.

### CROSS-REFERENCE TO RELATED APPLICATIONS

This application claims the benefit of U.S. Application No. 63/713,235 filed on Oct. 29, 2024, which is fully incorporated herein by reference.

### TECHNICAL FIELD

This disclosure relates to creating, transmitting, and rendering high dynamic range (HDR) content with dynamic color metadata.

### BACKGROUND

High Dynamic Range (HDR) content generally refers to content such as multimedia content including, but not limited to, images, animations, and/or video, that captures a dynamic range that is greater than the dynamic range that may be captured in content generated by a standard dynamic range camera sensor. The term “dynamic range” refers to the difference between the lightest light and the darkest dark of an image or frame of HDR content.

HDR content has become abundant in multimedia markets and applications. HDR content is generally created on so called “high-end” or “professional” displays. Professional displays are also referred to as HDR and wide color gamut (WCG) displays. Professional displays are characterized by relatively high peak luminance and WCG. For example, peak luminance of a high-end display used to create HDR content may have a peak luminance in the range of approximately 4,000 nits to approximately 10,000 nits and a WCG as generally set forth in ITU Recommendation BT.2020 for high-definition television (UHDTV). Content rendered on professional displays appears to users as being very bright and having vivid colors.

By comparison, consumer television products, e.g., consumer displays and/or panels, lack the brightness and WCG of professional displays necessary for accurate rendering of HDR content. In consequence, many consumer displays, being limited in their ability to fully and accurately reproduce HDR content, display HDR content with degraded visual quality. In view of this reality, HDR standards have an impact on how HDR content is rendered on consumer television products thereby playing a significant role in maintaining perceived visual quality of the HDR and WCG content displayed on various products including consumer level products.

### SUMMARY

In one or more embodiments, a method includes separating chroma data from luma data of high-dynamic range (HDR) content that includes a plurality of segments. The method includes generating, from the chroma data, dynamic color metadata for each segment of the plurality of segments of the HDR content. The dynamic color metadata specifies hue and saturation data for the HDR content on a per segment basis.

In one or more embodiments, a system or apparatus includes a hardware processor capable of executing operations. The operations include separating chroma data from luma data of high-dynamic range (HDR) content that includes a plurality of segments. The operations include generating, from the chroma data, dynamic color metadata for each segment of the plurality of segments of the HDR content. The dynamic color metadata specifies hue and saturation data for the HDR content on a per segment basis.

In one or more embodiments, a method includes receiving HDR content having color metadata encoded therewith for each segment of a plurality of segments of the HDR content. The method includes extracting the dynamic color metadata for the plurality of segments. The dynamic color metadata specifies hue and saturation data for the HDR content on a per segment basis. The method includes adjusting at least one of hue or saturation of one or more frames of one or more of the plurality of segments of the HDR content based on the color metadata as extracted.

In one or more embodiments, a system or apparatus includes a decoder that is capable of receiving HDR content having color metadata encoded therewith for each segment of a plurality of segments of the HDR content. The decoder is capable of extracting the dynamic color metadata for the plurality of segments. The dynamic color metadata specifies hue and saturation data for the HDR content on a per segment basis. The apparatus includes color enhancing hardware capable of adjusting at least one of hue or saturation of one or more frames of one or more of the plurality of segments of the HDR content based on the color metadata as extracted.

In one or more embodiments, a computer program product includes a computer readable storage medium having program instructions stored thereon. The program instructions are executable by a processor to perform the various operations described within this disclosure.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments; however, the accompanying drawings should not be taken to limit the disclosed technology to only the embodiments shown. Various aspects and advantages will become apparent upon review of the following detailed description and upon reference to the drawings.

FIG. 1 illustrates an example framework for high-dynamic range (HDR) content creation and distribution using dynamic color metadata in accordance with one or more embodiments of the disclosed technology.

FIG. 2 illustrates an implementation of a metadata extractor in accordance with one or more embodiments of the disclosed technology.

FIG. 3 illustrates an implementation of a dynamic color metadata generator in accordance with one or more embodiments of the disclosed technology.

FIG. 4 illustrates an example of dynamic color metadata for a segment of HD content.

FIG. 5 illustrates an example method of generating dynamic color metadata for HDR content in accordance with one or more embodiments of the disclosed technology.

FIG. 6 illustrates an example method of enhancing color of HDR content based on dynamic color metadata in accordance with one or more embodiments of the disclosed technology.

FIG. 7 illustrates an example of a data processing system for use with the embodiments of the disclosed technology.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to creating, transmitting, and rendering high dynamic range (HDR) content with dynamic color metadata. The dynamic color metadata may be specified as adaptive chromatic, e.g., color, statistics. The dynamic color metadata may be generated at or about or subsequent to the time the HDR content is created. Further, the dynamic color metadata may be generated at the content source so that the dynamic color metadata may be provided to other devices with the HDR content and used for image processing in the receiving device as part of visually rendering the HDR content.

In some embodiments, the dynamic metadata that is generated for HDR content is adaptive based on portions, e.g., segments, of the HDR content such as frames or a plurality of frames such as scenes. For example, a system may generate or calculate dynamic color metadata on a per segment basis for the HDR content. That is, dynamic color metadata will be generated based on the actual content, e.g., pixels of the particular frames in each segment of HDR content. In this regard, the dynamic color metadata may be segment-specific.

In some embodiments, the dynamic color metadata specifies hue and saturation data on a per segment basis. In some examples, the hue and saturation data may be specified as a joint distribution of hue and saturation data also referred to herein as a hue-saturation joint distribution and/or a two-dimensional (2D) chromatic distributions of hue and saturation. The dynamic color metadata may be specified per scene or per frame in any color space that isolates luma from chroma. In some examples, the disclosed technology is capable of generating the dynamic color metadata as a hue-saturation joint distribution specified on a per segment basis. The hue-saturation joint distribution may be specified as a histogram.

The dynamic color metadata may be encoded with the HDR content and transmitted, sent, provided, or broadcast to receiving devices such as display devices. The receiving devices are capable of extracting the dynamic color metadata from the received HDR content, along with any other metadata that may be included with the HDR content. The receiving devices, which may be or include consumer displays, are capable of enhancing or modifying the color of the HDR content based on the dynamic color metadata and do so on a per segment basis. For example, the color enhancement and/or modification performed may vary from segment to segment based on the particular dynamic color metadata for that segment. The receiving devices may then display or render the received HDR content as modified.

The use of the dynamic color metadata by a receiving device having a display with limited peak luminance and/or limited color display capabilities allows the receiving device to compensate for such limitations to preserve as much of the original intent of the HDR content as possible. Though different receiving devices may have different capabilities/limitations, each different receiving device may use the provided dynamic color metadata to adjust/modify coloring of the HDR content to enhance the originally created color in a manner that results in a more vivid rendering of the HDR content on that particular display than would have been the case had the dynamic color metadata not been provided.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

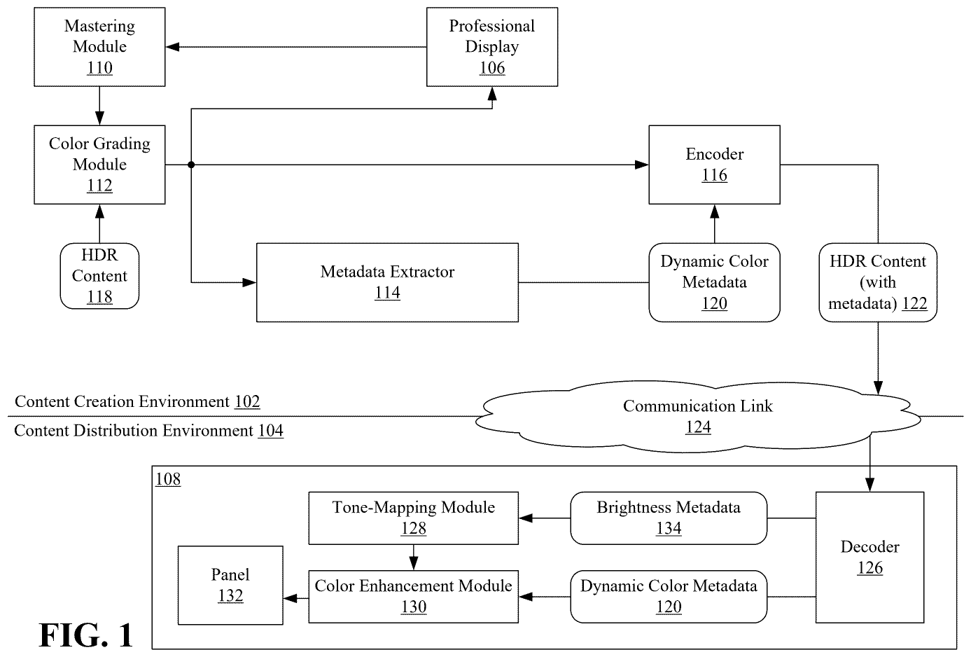

FIG. 1 illustrates an example framework for HDR content creation and distribution using dynamic color metadata in accordance with one or more embodiments of the disclosed technology. In the example, a content creation environment 102 and a content distribution environment 104 are illustrated.

Content creation environment 102 may be implemented as one or more computer systems that execute suitable software to perform the operations described. Content creators may utilize the computing systems within content creation environment 102 to edit and/or enhance color of HDR content. In general, content creation environment 102 is illustrative of certain image processing operations performed as part of a post-production process using computer systems. Though content creation environment 102 illustrates various processes, a professional display 106 suitable for HDR content mastering is shown to better illustrate HDR content creation and/or post-production editing as an example environment in which dynamic color metadata may be generated for HDR content and encoded therewith for transmission.

Content distribution environment 104 represents a receiving device 108. Receiving device 108 may be any device including one or more panels or screens capable of displaying or rendering content including HDR content. For example, the display device may be a television, a computer monitor, a computing device such as a laptop or tablet, a mobile device such as a mobile phone, an information appliance, a gaming system having or coupled to a display, or a wearable device such as virtual reality glasses, smartwatch, or the like.

In one or more examples, receiving device 108 may be a consumer display device. The disclosed technology is not intended to be limited by the particular type of receiving device 108. For example, receiving device 108 may be implemented as any of a variety of different devices including higher quality or so-called professional display devices. In this regard, the disclosed technology can be used in HDR broadcasting and/or HDR streaming fields. The disclosed technology may be incorporated into HDR products such as HDR & WGC televisions, displays, panels, high-end monitors such as gaming monitors, or software applications executable by hardware in content creation systems and/or content consumption systems. Further, the disclosed technology may be used within or as part of existing HDR standards such as, for example, HDR10+ and provide benefits to HDR10+ adopters (e.g., in the entertainment industry) and/or future contemplated or to be developed HDR standards.

For purposes of illustration, content creation environment 102 includes an executable architecture including executable components such as a mastering module 110, a color grading module 112, a metadata extractor 114, and an encoder 116. Mastering module 110 may be executable to provide a user interface through which a user may manually specify or adjust settings to be applied to HDR content 118 such as brightness, contrast, saturation, and color (e.g., huc) balance, using manual controls. In other examples, mastering module 110 may provide functionality that automates one or more or all of the aforementioned settings.

Color grading module 112 is capable of adjusting and/or modifying HDR content 118 as part of a post-production process (e.g., in film and/or video editing) where the colors and tone of images of HDR content are manipulated to create a specific visual style and mood. Color grading module 112 may operate responsive to input from mastering module 110 to fix technical issues with HDR content 118 and/or to adjust coloring to realize an artistic vision of what HDR content 118 should look like when displayed or visually rendered. A content creator user, e.g., a colorist, may apply edits to HDR content 118 by working through mastering module 110 to control color grading module 112 based on observation of the HDR content 118, or a processed version HDR content 118, as displayed on professional display 106. Because HDR content is generally created/enhanced by colorists (e.g., human artists) on professional displays with high brightness and very wide color gamut, the resulting HDR content usually looks brighter when displayed and has very vivid colors. Vivid colors are obtained through good saturation, high color contrast, etc.

In one or more embodiments, metadata extractor 114 is capable of generating dynamic color metadata 120 from HDR content 118 or a processed version thereof (hereafter both referred to as “HDR content 118”). Dynamic color metadata 120 may be generated by metadata extractor 114 as part of the content creation and/or post-production process or subsequent to such processes. In the example, metadata extractor 114 is capable of generating dynamic color metadata 120 for each different segment of HDR content 118.

Within this disclosure, the term “segment,” in reference to HDR content, refers to a portion of the HDR content that includes one or more images. The term “image,” in the context of HDR content, e.g., video, multimedia, or an animation, is used synonymously with a frame of such content. In this regard, a segment of HDR content 118 may refer to a single frame, or a plurality of frames such as a scene of HDR content. This delineation or segmentation of HDR content allows different dynamic color metadata 120 to be generated for each segment. That is, dynamic color metadata 120 may be segment-specific in that the dynamic color metadata 120 changes over time (e.g., for each segment) by adapting to the qualities and/or characteristics of the respective segments of HDR content 118.

Encoder 116 is capable of encoding dynamic color metadata 120 with HDR content 118 to generate HDR content 122 having dynamic color metadata 120 embedded therein or encoded therewith. While the embodiments of the disclosed technology provide dynamic color metadata, it should be appreciated that other available and/or known forms of metadata for HDR content such as static color metadata, static and/or dynamic brightness metadata also may be generated using available and/or known techniques and encoded with HDR content 118 resulting in HDR content 122.

Dynamic color metadata 120 provides several advantages for improving visual quality of HDR content particularly as displayed on receiving devices and, in particular, receiving devices such as consumer display devices that tend to be limited or constrained in terms of brightness or color gamut. Such is the case as dynamic color metadata 120 provides segment (e.g., frame and/or scene) specific descriptions of HDR content 122. These advantages are described in greater detail hereinbelow and differ from other existing metadata that may accompany HDR content. Existing metadata that typically accompanies HDR content is predominantly related to brightness processing. Some metadata may be color related. Existing color related metadata such as, for example, white point, color primaries, and/or a color transferring matrix, however, are static. That is, such color metadata remains constant from one segment of HDR content to another (e.g., does not change from one segment of the HDR content to another).

HDR content 122 may be sent or provided to receiving device 108 in content distribution environment 104 via communication link 124. In the example, communication link 124 may be implemented as or represent any of a variety of different content distribution methods, techniques, channels, or the like. For example, communication link 124 may be illustrative of an Over-The-Top (OTT) streaming service capable of delivering HDR content directly to end users over the Internet (e.g., bypassing traditional broadcast or cable providers). In other examples, communication link 124 may be illustrative of a traditional broadcast channel and/or cable connection. In still other examples, communication link 124 may be illustrative of other connections such as High-Definition Multimedia Interface (HDMI), Universal Serial Bus (USB), or the like.

For purposes of illustration and not limitation, receiving device 108 may receive HDR content 122 via communication link 124 via a cable receiver/modem, a wireless antenna system, an Internet appliance, Internet modem or access point, or other network interface/adapter device. As illustrated, receiving device 108 may include a decoder 126, a tone-mapping module 128, a color enhancement module 130, and a display or panel 132 that is capable of displaying or rendering HDR content thereon.

Decoder 126 is capable of decoding HDR content 122 to extract the various types of metadata therefrom. In the example, decoder 126 extracts brightness metadata 134 and dynamic color metadata 120 from HDR content 122. Dynamic metadata 134 may be provided to tone-mapping module 128 to adjust and/or modify brightness of HDR content 122. HDR content 122 may be provided to color enhancement module 130 to adjust and/or modify color of HDR content 122. As noted, the particular color enhancement and/or modification performed on the HDR content will vary from one segment to another based on the particular dynamic color metadata for that segment. The resulting HDR content, as modified by tone-mapping module 128 and/or color enhancement module 130, may be provided to panel 132 and displayed. In the example, brightness metadata 134 and tone-mapping module 128 are included to illustrate how dynamic color metadata 120 may be used within a receiving device, but are not intended as limitations of the embodiments of the disclosed technology.

In one or more embodiments, display devices such as receiving device 108 may include various types of image processing circuitry or hardware. Such hardware may include one or more image processors such as specialized Application-Specific Integrated Circuits (ASICs), Graphics Processing Units (GPUs), Digital Signal Processors (DSPs), Intellectual Property (IP) cores, other circuits, etc., that are designed to perform particular image processing operations, functions, and/or algorithms. Such operations may include, for example, performing the decoding described, color enhancement, and/or color expansion. Such image processing hardware may utilize dynamic color metadata 120 to perform one or more of the image processing operations. In using dynamic color metadata 120 to perform color-related image processing operations, and doing so on a per segment basis with segment-specific dynamic color metadata 120, increased visual quality of the HDR content 122 may be achieved particularly given any limitations in receiving device 108 as to ability to display brightness and/or color gamut.

As discussed, limitations of some display devices prevent accurate reproduction of the original visual quality of HDR content. Consumer displays depend on metadata accompanying the HDR content to improve the visual quality of the HDR content as displayed to overcome or mitigate these limitations. As noted, existing standards and/or conventions provide dynamic brightness descriptions in the metadata. Using this metadata, consumer displays can recover parts of immersive visual quality of the HDR content to a high degree. In the conventional case, however, since color-related metadata are static, the color-related metadata remains unchanged from one segment to the next (e.g., does not change from one segment of the HDR content to the next). The static nature of the color-related metadata results in various issues with the display of HDR content that may include, but are not limited to, problematic saturation levels of the colors, color contrast loss, and loss of hue-adaptations.

Problematic saturation levels of colors include over-saturated colors and/or less (e.g., under) saturated colors while displaying HDR content at various points in time. Because the color-related metadata is static, performing color enhancement often results in some scenes being over-saturated while other scenes are under-saturated. The saturation adjustment performed in many consumer displays applies the static color-related metadata that, while applicable to HDR content such as a movie or television show taken as a whole, does not reflect the actual content being played at any given instance. Dynamic color metadata helps improve color quality of HDR content by providing color metadata that does change over time and that does adapt based on the particular segment of HDR content being played at any given time.

Color contrast loss refers to a reduction in color contrast in the display of HDR content. High color contrast is important to reproduce the vividness of color expected from HDR content. Without dynamic color metadata, consumer displays have no information on color distributions of different hues and/or the relationship between different hues. As such, color-related image processing hardware of a display device has difficulty improving color contrast in an effective manner.

Loss of hue-adaptations can significantly affect different psychophysical effects experienced by human beings while viewing HDR content. These psychophysical effects, which are hue-adaptive, may shape human perception and/or actions to the HDR content. Providing dynamic color metadata allows a display device to apply hue-adaptive processing to further recover the original HDR color quality. Without dynamic color metadata, display devices may be unable to perform any type of effective hue-adaptive image processing.

Metadata extractor 114 is capable of addressing these issues by generating dynamic color metadata 120 that may provide base information of content colors from which color-related image processing hardware in display devices including consumer displays, can generate sufficient, effective matrices for color quality enhancement. Dynamic color metadata 120, as described herein, may be generated to meet several different requirements or metrics.

As noted, dynamic color metadata 120 is adaptive to different segments, e.g., individual frames and/or groups of frames such as scenes. Unlike static color information, which is constant for different segments, dynamic color metadata 120 may represent different properties and/or values for such properties for different scenes. In using dynamic color metadata 120, color-related image processing hardware within receiving devices is capable of dynamically processing colors for different segments of HDR content (e.g., enhancing color in different ways for different segments) and achieving segment-adaptive or segment-specific high visual quality when displaying the HDR content.

Dynamic color metadata 120 is also derivable. Derivability means that color-related image processing hardware may obtain multiple useful color properties or matrices from dynamic color metadata 120 for performing adaptive color quality improvement of HDR content. In general, the size of metadata is small due to the limited bandwidth of broadcasting channels. This makes it difficult to add many color features into the metadata. Color-related image processing hardware, however, may need different color properties or matrices to effectively improve color quality in different display devices. For example, different display devices (e.g., different brands and/or models) may have different hardware and/or limitations as to brightness and color gamut requiring the color-related image processing hardware in different display devices to make color enhancements that differ from those made in other display devices.

For purposes of illustration, consider the case in which gamut compression hardware needs color boundary information to enhance particular segments of HDR content. In another example, color enhancing hardware may require saturation distribution information to enhance color of particular segments of HDR content. In still another example, hue-adaptive hardware may need information pertaining to the specific hues of the HDR content. Dynamic color metadata 120, as described herein, may be used as a baseline from which multiple color features may be obtained for different applications. As noted, these multiple color features are segment-specific for the HDR content.

Dynamic color metadata 120 is also efficient and economical for broadcasting applications. Due to the cost and the bandwidth limitations of broadcasting channels, dynamic color metadata 120 is space efficient in that the dynamic metadata is small in terms of data size. Further, dynamic color metadata 120 is low-cost to apply and/or use in the receiving displays in that the dynamic color metadata may be used by color-related image processing hardware in receiving devices to generate different types of color-related information with reduced or minimal computational burden on the hardware of the receiving device.

In one or more examples, dynamic color metadata 120 may be implemented or specified as a joint distribution of hue and saturation of colors. The joint distribution of hue and saturation of colors may be denoted as c˜C_{H,S}(h, s), where H and S are random variables of the hue and saturation in HDR content, respectively. For purposes of illustration, let f_{H,S}(h, s) be the hue-saturation joint distribution function of C as set forth in Expression 1 below.

$${f}_{H , S} ( h , s ) = \frac{{\partial }^{2} {C}_{H , S} ( h , s )}{\partial h \partial s} \qquad ( 1 )$$

Using the hue-saturation joint distribution from Expression 1 as dynamic color metadata 120 provides various benefits. For example, the distributions can be computed in practice meaning that the size of the dataset can be dynamically determined for concrete applications. In addition, the hue-saturation joint distribution may be suitable for use as dynamic color metadata for the generation of HDR metadata in compliance with existing HDR standards such as HDR10+ and/or further HDR standards developed in furtherance of, or based on, HDR10+ technology for adding dynamic metadata to HDR10 compliant source/content files. Further, the hue-saturation joint distribution, as set forth in Expression 1, also meets the requirements or metrics of being segment adaptive, being derivable, and being economical.

Regarding segment adaptivity, different segments of HDR content will have different colors. As such, the hue and the saturation of a specific segment may be very different from the hue and saturation of a different segment of same HDR content. For example, different scenes of a movie or television show will likely have different hue and saturation. As such, dynamic color metadata 120, expressed as a hue-saturation joint distribution, makes it highly unlikely that two different segments will have same or similar dynamic color metadata. These properties allow dynamic color metadata 120 to provide color-related image processing hardware in display devices with strong support for the generation of unique matrices of colors on a per segment basis resulting in color processing that achieves increased content-adaptive, color enhancing results.

Regarding derivability, color-related image processing hardware is capable of obtaining, e.g., deriving, a plurality of different color properties that may be used depending on the particular application of the color-related image processing hardware and/or receiving display. For purposes of illustration and not limitation, the following are examples of different color properties that may be derived from dynamic color metadata 120 by a receiving display and used by color-related image processing hardware to enhance color of different segments of HDR content.

In one or more examples, color-related image processing hardware may derive the marginal distribution of H from Expression 1. The marginal distribution of H, denoted as f_{H}(h), from Expression 1 specifies the hue statistics of the current segment. The marginal distribution of H may be derived based on Expression 2 below.

$${f}_{H} ( h ) = {\int }_{S} {f}_{H , S} ( h , s ) ds \qquad ( 2 )$$

With the hue statistics obtained using Expression 2 for each of a plurality of different segments of HDR content, color-related image processing hardware is capable of effectively carrying out hue-adaptive processing. The hue-adaptive processing may be performed and adapted on a per segment basis as dynamic color metadata 120, and as such the marginal distribution of H, changes and may be obtained on a per segment basis.

In one or more examples, the marginal distribution of H also provides the perceptual opposite hue information. The perceptual opposite hue information may be used by color-related image processing hardware to significantly improve the color contrast in HDR content that is displayed.

In one or more examples, color-related image processing hardware may derive the marginal distribution of S from Expression 1. The marginal distribution of S, denoted as f_{S}(s), from Expression 1 specifies the saturation statistics of the current segment. The marginal distribution of S may be derived based on Expression 3 below.

$${f}_{S} ( s ) = {\int }_{H} {f}_{S , H} ( h , s ) dh \qquad ( 3 )$$

With the saturation statistics obtained using Expression 3 for each of a plurality of different segments of HDR content, color-related image processing hardware is capable of effectively carrying out saturation-adaptive processing. The saturation-adaptive processing may be performed and adapted on a per segment basis as dynamic color metadata 120, and as such the marginal distribution of H, changes on a per segment basis. Saturation-adaptive processing performed using the marginal distribution of S is capable of applying more specific, e.g., segment specific, color enhancing to obtain vivid colors while avoiding significantly over-saturated and/or under-saturated colors.

In the examples discussed above, chroma information such as hue (e.g., the marginal distribution of H) and/or saturation (e.g., the marginal distribution of S), may be obtained or derived from the hue-saturation joint distribution. Such information, e.g., chroma information for HDR content, however, may not be obtained directly from color spaces such as the RGB color space. Within the RGB color space, hue and saturation are inseparable, e.g., are comingled. To obtain hue and saturation information, particularly where hue data is specified separately and/or independently from saturation data, image data specified in the red-green-blue (RGB) color space must first be translated into a different color space that supports specifying hue and saturation data independently. An example of such a color space is the color appearance model (CAM) CIE-LCH (e.g., as defined by Commission Internationale de l'Eclairage (CIE)) described below in greater detail or other such color spaces/domains. In this regard, the use of hue-saturation joint distribution as dynamic color metadata 120 provides added benefit in that the amount of information contained in the hue-saturation joint distribution is large particularly considering the information indirectly specified by dynamic color metadata 120 that may be derived therefrom as discussed above.

In one or more examples, image processing hardware may use the hue-saturation joint distribution with luminance information/metadata for particular segments of HDR content to obtain gamut boundary information from the conditional distributions of different hues. The gamut boundary information may be used on a per segment basis by image processing hardware in and/or associated with the receiving device.

Regarding economy, using hue-saturation joint distribution as dynamic color metadata 120 is economical in terms of the size of the color dynamic metadata. The hue-saturation joint distribution is also flexible in that it may be used for a variety of different processing types. As an illustrative and nonlimiting example, the hue-saturation joint distribution may be imitated or represented by counting pixels of the given segments of HDR content. The hue and the saturation of a segment may be discrete by quantizing hue into N quantization levels and quantizing saturation into M quantization levels. For example, an N×M matrix may be used to represent the hue-saturation joint distribution for a given segment. By controlling the values of N and M, the size of dynamic color metadata 120 may be controlled. In use cases where greater economy is desired (e.g., for more cost-efficient products), the values for N and M may be relatively low. For other high-end or higher quality products such as more expensive display devices, values of N and M may be larger. In a software application use case, the values of N and M may be even larger as greater processing power may be readily available. As such, using the hue-saturation joint distribution provides significant flexibility as to the size of dynamic color metadata 120 provided and may vary based on the particular use case and/or application.

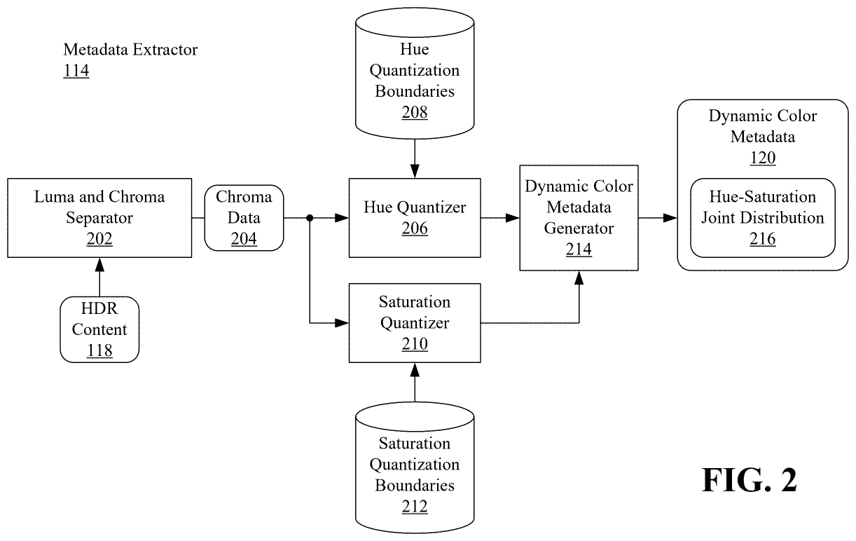

FIG. 2 illustrates an implementation of metadata extractor 114 in accordance with one or more embodiments of the disclosed technology. FIG. 2 also illustrates system-level computations that may be performed in generating dynamic color metadata 120 in the form of hue-saturation joint distributions described above. In one or more embodiments, metadata extractor 114 includes a luma and chroma separator 202, a hue quantizer 206, a saturation quantizer 210, and a dynamic color metadata generator 214. Hue quantization boundaries 208 and saturation quantization boundaries 212 also are included.

In the example, HDR content 118 may be provided to metadata extractor 114 and, more particularly, to luma and chroma separator 202. HDR content 118 may be provided as a file in any of a variety of different known or available file formats. Luma and chroma separator 202 is capable of operating on HDR content 118 to separate the luma components or data from the chroma components or data. As illustrated, luma and chroma separator 202 is capable of outputting chroma data 204.

In one or more embodiments, HDR content 118 may be specified in the RGB color space or domain. To generate dynamic color metadata 120 from HDR content 118, the chroma data of HDR content 118 is separated from the luma data. In one or more examples, metadata extractor 114 is capable of generating dynamic color metadata 120 from HDR content 118 specified in any of a variety of color models/spaces in which chroma data may be separated from luma data. For purposes of illustration, example color models that also may be used with metadata extractor 114 can include, but are not limited to, the color appearance model (CAM) CIE-LCH (e.g., as defined by Commission Internationale de l'Eclairage (CIE)) where L indicates lightness, C represents chroma or saturation, and H represents hue and/or the HSI model capable of representing color with three components including hue (H), saturation(S), and intensity (I). For example, HDR content specified in the RGB color space may first be converted to an appropriate color space that is capable of specifying hue data independently of saturation data such as CIE-LCH or another suitable color space/domain.

It should be appreciated that since metadata extractor 114 may be implemented on, and performed by, computing and/or image processing systems of content creators and/or broadcasters (e.g., as opposed to end-user or consumer type devices), sufficient computing power is typically available such that there is less concern over computational complexity of operations such as chroma and luma separation.

Continuing with the example of FIG. 2, chroma data 204, e.g., only chroma data 204, is provided to each of hue quantizer 206 and saturation quantizer 210. Both hue quantizer 206 and saturation quantizer 210 may operate only on chroma data 204. That is neither hue quantizer 206 nor saturation quantizer 210 needs access to, or operates on, the luma data of HDR content 118. Chroma data 204 may include hue data and saturation data. In general, hue quantizer 206 is capable of quantizing the hue data portion of chroma data 204. Saturation quantizer 210 is capable of quantizing the saturation data portion of chroma data 204.

In quantizing the hue and saturation data, hue quantizer 206 and saturation quantizer 210 are capable of representing hue and saturation, respectively, with numerical values for purposes of computing their joint distributions. In the example, hue quantization boundaries 208 may specify ranges of values for hue with each range defining or delineating a particular hue or color. The ranges differentiate one hue from another, e.g., mark the boundary between an end of a color and the start of a next color for a plurality of different colors. Hue quantization boundaries 208 may be used by hue quantizer 206 to quantize the hue data into N hue groups or quantization levels, where N is an integer value greater than 1. The number of N hue quantization levels may be predetermined. Each hue group will contain pixels of a given segment of HDR content having a hue value within the defined range for the group as specified by hue quantization boundaries 208. Each of the N hue groups will include some number of pixels of HDR content 118 for a given segment having a hue value in the defined range for the hue group.

Similarly, saturation quantization boundaries 212 may specify ranges of values for saturation with each range defining or delineating a particular saturation classification or quantization level of saturation. The ranges differentiate one saturation level from another, e.g., mark the boundary between an end of a saturation level and the start of a next saturation level. Saturation quantization boundaries 212 may be used by saturation quantizer 210 to quantize the saturation data into M saturation classifications or quantization levels, where M is an integer value greater than 1. The number of M saturation quantization levels may be predetermined. Each saturation classification contains pixels of a given segment having a saturation value within the defined range for the group as specified by saturation quantization boundaries 212. Each of the M saturation classifications will include some number of pixels of HDR content 118 for a given segment having a saturation value in the defined range for the saturation classification.

In one or more embodiments, the quantization of hue data and/or saturation data may be quantized using a linear approach. That is, the defined ranges for hue defined by hue quantization boundaries 208 each may be the same, where a difference between the upper value of each range and the lower value of each range is the same. Similarly, the defined ranges for saturation defined by saturation quantization boundaries 212 each may be the same, where a difference between the upper value of each range and the lower value of each range is the same.

In one or more other embodiments, the quantization of hue data and/or saturation data may be quantized using a non-linear approach. In the non-linear approach, one or more or all of the defined ranges for hue as defined by hue quantization boundaries 208 may differ. The ranges for hue may be compared by taking a difference between an upper value of each range and the lower value of each range. Similarly, one or more or all of the defined ranges for saturation defined by saturation quantization boundaries 212 may be different. The ranges for saturation may be compared by taking a difference between an upper value of each range and the lower value of each range.

In one or more examples, whether using a linear approach for quantization or a non-linear approach for quantization, the ranges for hue and/or saturation may be created to track or correspond to, the HVS. Using HVS as a guide for setting ranges of hue and/or saturation for quantization may improve user perceptual color quality. In some embodiments, the ranges defined by hue quantization boundaries 208 and/or saturation quantization boundaries 212 may be the same as, or based on, CAM. The values may be converted to a target (e.g., working) color space. The values, as converted, may then be saved as hue quantization boundaries 208 and saturation quantization boundaries 212 for purposes of quantization.

In the case where a linear approach to quantization of hue and/or saturation is used and based on the HVS, different hue and/or saturation levels are considered to be equal in terms of importance to one another. In cases where a non-linear approach to quantization is used, different hue and/or saturation levels may be considered more important than others and weighted accordingly. As an example, human beings may be more sensitive to changes in blue and less sensitive to changes in green. It may be beneficial to provide increased granularity, e.g., have more quantization levels, for particular hues to which human beings have increased sensitivity such as blue.

The quantized hue data as output from hue quantizer 206 and the quantized saturation data as output from saturation quantizer 210 may be provided to dynamic color metadata generator 214. For example, for each pixel that is processed by hue quantizer 206, that pixel may be assigned a particular hue quantization level of the N hue quantization levels. Similarly, for each pixel that is processed by saturation quantizer 210, that pixel may be assigned a particular saturation quantization level of the M saturation quantization levels. This allows each pixel, processed through both hue quantizer 206 and saturation quantizer 210, to be assigned to both a particular hue quantization level and a particular saturation quantization level. Dynamic color metadata generator 214 is capable of generating distributions of hue and saturation. In one or more examples, dynamic color metadata generator 214 is capable of generating hue-saturation joint distributions 216.

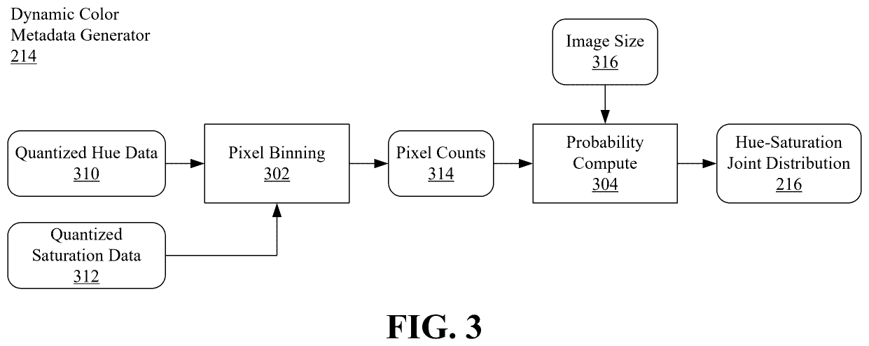

FIG. 3 illustrates an implementation of dynamic color metadata generator 214 in accordance with one or more embodiments of the disclosed technology. In the example of FIG. 3, dynamic color metadata generator 214 includes a pixel binning block 302 and a probably compute block 304.

As illustrated, pixel binning block 302 receives quantized hue data 310 as output from hue quantizer 206 and quantized saturation data 312 as output from saturation quantizer 210. As discussed in connection with FIG. 2, quantized hue data 310 is quantized based on hue boundaries that may be specified as linear boundaries or as non-linear boundaries. Similarly, quantized saturation data 312 is quantized based on perceptual quality-based saturation boundaries that may be specified as linear boundaries or as non-linear boundaries. Accordingly, pixel binning block 302 is capable of assigning each pixel of HDR content to a particular bin of N×M bins corresponding to the N hue quantization levels and the M saturation quantization levels. Each bin includes pixels belonging to a particular N hue quantization level and a particular M saturation quantization level. Pixel binning block 302 outputs pixel counts 314. Pixel counts 314 may include a pixel count for each bin specifying a number of pixels included in that bin.

Probability compute block 304 is capable of generating hue-saturation joint distribution 216 based on the received pixel counts 314 and an image size 316. Image size 316 specifies the size, e.g., pixel count that may be specified in 2 dimensions, of each frame of HDR content. Probably compute block 304 is capable of generating a hue-saturation joint distribution 216 for each segment of HDR content, e.g., generating a hue-saturation joint distribution 216 on a per segment basis. In one or more embodiments, hue-saturation joint distribution 216 may be specified, or implemented, as a 2D histogram on a per segment basis.

In one or more examples, the hue data and the saturation data need not be specified in the same color domain. For example, in other embodiments, the hue data and the saturation data can be represented by different matrices in different color domains.

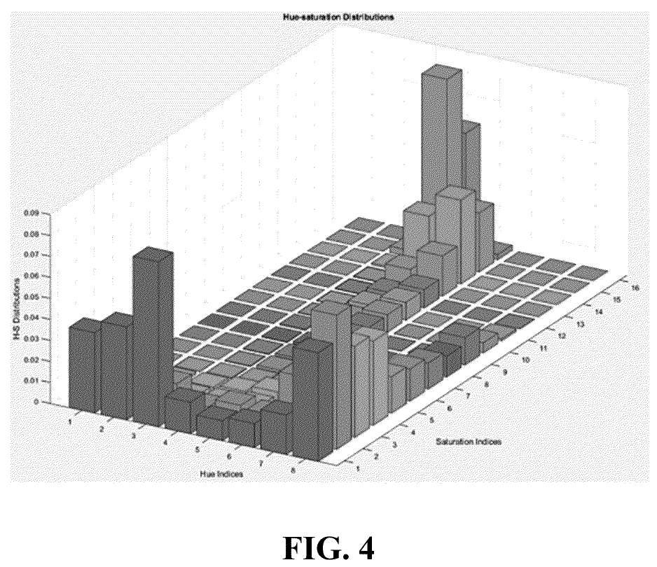

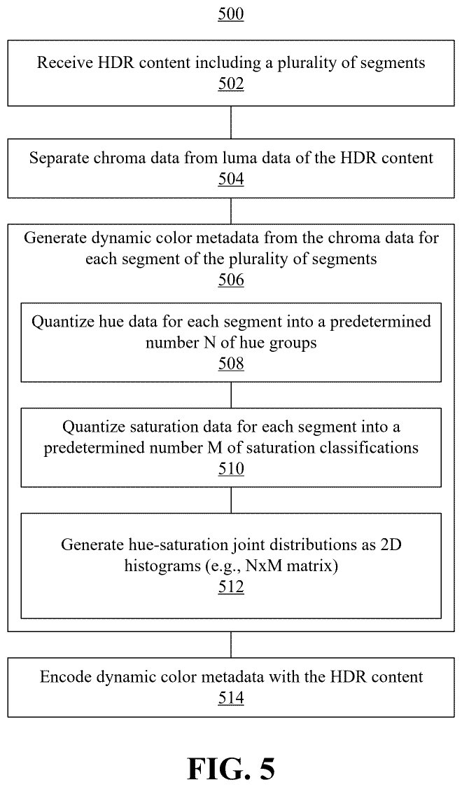

FIG. 4 illustrates an example of color metadata 120 in accordance with one or more embodiments of the disclosed technology. More particularly, FIG. 5 illustrates an example of hue-saturation joint distribution 216 represented as a 2D histogram for a given segment of HD content, e.g., a frame in this example. In the example of FIG. 4, the 2D histogram includes 8 different hue groups (e.g., N=8) and 16 different saturation classifications (e.g., M=16). The vertical height of each bin denoted with the coordinate (N, M) indicates a number of pixels in that bin. The 2D histogram illustrated in FIG. 4 may be in the CIE-LCH domain.

FIG. 5 illustrates an example method 500 of generating dynamic color metadata for HDR content in accordance with one or more embodiments of the disclosed technology. Method 500 may be performed by one or more computer systems as may be implemented as part of content creation environment 102 of FIG. 1 and, more particularly, by metadata extractor 114 and encoder 116.

In block 502, metadata extractor 114 is capable of receiving HDR content such as HDR content 118. As noted, HDR content 118 may be processed or color adjusted. The HDR content may be a video. The HDR content includes a plurality of segments. In this regard, the HDR content may include or be accompanied by segment indicators that specify the beginning and ending of the segments contained therein. As discussed, each segment includes one or more frames. In some examples, a segment may be a scene of the HDR content.

In block 504, metadata extractor 114 is capable of separating the chroma data from the luma data of the HDR content. As discussed, luma and chroma separator 202 is capable of separating the chroma data from the luma data and outputting chroma data 204 to each of huc quantizer 206 and saturation quantizer 210.

In block 506, metadata extractor 114 is capable of generating, from the chroma data 204, dynamic color metadata 120. Metadata extractor 114 is capable of generating dynamic color metadata 120 for each segment of the plurality of segments of the HDR content. In generating dynamic color metadata 120, metadata extractor 114 may only utilize chroma data 204 and, in doing so, exclude or omit luma data from consideration and/or use in generating dynamic color metadata 120. Dynamic color metadata 120 may be specified, on a per segment basis, as hue and saturation data for the HDR content.

In generating dynamic color metadata 120, metadata extractor 114 is capable of performing a variety of operations. For example, in block 508, hue quantizer 206 is capable of quantizing hue data (e.g., from the chroma data 204) for each segment into a predetermined number N of hue quantization levels. In block 510, saturation quantizer 210 is capable of quantizing saturation data for each segment into a predetermined number M of saturation quantization levels.

In one or more examples, the N hue quantization levels have non-linear boundaries. In one or more other examples, the N hue quantization levels have linear boundaries. In either case, the boundaries may be determined based on the HVS. In one or more examples, the M saturation quantization levels have non-linear boundaries. In one or more other examples, the M saturation quantization levels have linear boundaries. In either case, the boundaries may be determined based on the HVS.

In block 512, for each segment, the hue and saturation data may be generated as an N× M matrix (e.g., as 2D histogram) specifying a hue-saturation joint distribution for the segment. As such, dynamic color metadata 120 is dynamically adapted to each segment. That is, each segment has segment-specific dynamic color metadata 120 that will differ from the dynamic color metadata 120 of other segments of HDR content. The 2D histograms of different segments will differ from one another and from a 2D histogram of the entire HDR content (e.g., video).

By specifying dynamic color metadata 120 as hue-saturation joint distributions, e.g., as a discrete 2D histogram for each segment, a marginal distribution of hue may be derived, e.g., is derivable from dynamic color metadata 120, for each segment. Similarly, a marginal distribution of saturation may be derived, e.g., is derivable, from dynamic color metadata 120 for each segment.

In block 514, encoder 116 is capable of encoding dynamic color metadata 120 with the HDR content resulting in HDR content 122. In one or more embodiments, dynamic color metadata 120 may include the hue-saturation joint distributions as 2D histograms.

In some embodiments, the dynamic color metadata 120, as encoded within HDR content 122, also may include hue boundary information and saturation boundary information. In general, for linear quantization cases, the quantization boundaries need not be transmitted as part of the dynamic color metadata since those boundaries may be defined within a specification document. In non-linear quantization cases, if the quantization boundaries are well designed based on the properties of the HVS, the boundaries do not need to be transmitted with the dynamic color metadata as they too may be defined within a specification document. In cases where the quantization boundaries are dynamically determined for different HDR content, such boundary information may be transmitted with the dynamic color metadata. In such cases, the boundary information may be transmitted with the start or beginning of the HDR content. In other cases, e.g., where the boundary information may change from segment to segment for the HDR content, the boundary information may be transmitted on a per-segment basis or for those segments in which the boundary information changes.

It should be appreciated that each segment-specific dynamic color metadata may be aligned or associated with the particular segment described by the metadata so that the receiving device 108 may determine which segment to apply a given set of dynamic color metadata. Alignment and/or association may be achieved by using like identifiers between segments and the dynamic metadata for the respective segments. The identifiers may be based on numbered sequences of images/frames in each segment, a time code of sequenced images/frames in each segment, or other alignment technique.

It should be appreciated that other forms of metadata, whether static and/or dynamic, may be encoded with HDR content in addition to dynamic color metadata 120. Examples of other metadata may include static color metadata, static brightness metadata, and/or dynamic brightness metadata. As discussed, HDR content 122 having dynamic color metadata 120 encoded therewith may be sent, provided, broadcast, etc., to one or more other receiving devices for display thereon.

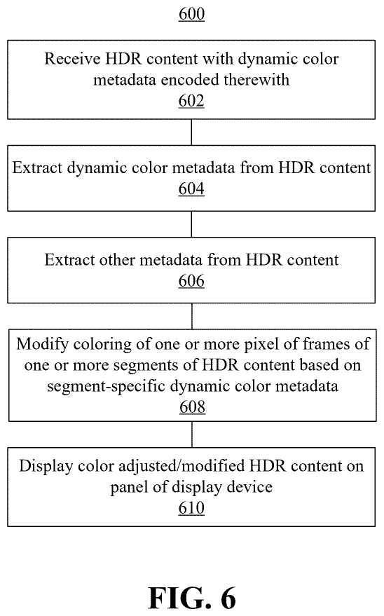

FIG. 6 illustrates an example method 600 of using dynamic color metadata for enhancing coloring of HDR content in accordance with one or more embodiments of the disclosed technology. Method 600 may be performed by a display device having hardware (e.g., dedicated circuitry and/or hardware processors) that are capable of performing the image processing operations described herein that may be implemented as part of content distribution environment 104 and, more particularly, by receiving device 108.

In block 602, receiving device 108 is capable of receiving, HDR content 122 (e.g., HDR content with dynamic color metadata encoded therewith). For example, decoder 126 is capable of receiving HDR content 122. In block 604, decoder 126 is capable of extracting dynamic color metadata 120 from HDR content 122. In block 606, decoder 126 is capable of extracting any other metadata that may have been encoded with, or as part of, HDR content 122. Block 606 may be optional depending on the availability of other metadata included with HDR content 122.

In block 608, a color enhancement module 130 is capable of modifying coloring (e.g., hue and/or saturation) of one or more pixels of frames of one or more segments based on the segment-specific dynamic color metadata 120. For example, color enhancement module 130 is capable of adjusting at least one of hue and/or saturation of one or more pixels of one or more frames based on, and in response to, dynamic color metadata 120 on a per segment basis. As noted the particular enhancement/modifications and/or amounts thereof applied to each segment may vary based on the particular dynamic color metadata for that segment. In block 610, receiving device 108 is capable of displaying the HDR content, as modified or adjusted by color enhancement module 130, on panel 132.

The embodiments of the disclosed technology allow image processing hardware such as color enhancement module 130 to perform sophisticated image processing based on properties of the HVS, the HDR content, and hardware limitations of receiving device 108 itself as to brightness and or color gamut.

As noted, both linear and non-linear quantization of continuous hue and saturation data may be used to compute hue-saturation joint distributions and representing such joint distributions in discrete form as 2D histograms. Using non-linear quantization, however, allows dynamic color metadata 120 to specify hue-saturation joint distributions that satisfy some properties of the HVS that may not be satisfied using linear quantization. Storing this non-linear data, however, also increases the storage requirements as dynamic color metadata 120 may include the quantization boundary information for each of hue and saturation. In this regard, dynamic color metadata 120 may include the hue-saturation joint distribution, hue quantization boundaries 208, and saturation quantization boundaries 212. This data may be encoded as discussed below to reduce the total number of bits required to store and/or convey such data.

In the case of storing quantization boundaries, consider an example where q is the bit depth of a quantization boundary, whether for hue and/or saturation, and N is the number of quantization boundaries. In that general case, q×N bits are required to store one set (e.g., for hue or for saturation) of quantization boundaries. When the precision of quantization is relatively high, the number of bits q required for each boundary will increase thereby increasing the total amount of space/bits required to store the quantization boundaries referred to herein as the “bit budget.”

In one or more embodiments, metadata extractor 114 is capable of representing quantization boundaries using a basic quantization interval ω. The distance between two consecutive boundaries, whether for hue and/or saturation, may be specified as an integer number of such basic quantization intervals ω. As such, metadata extractor 114 is capable of specifying or representing a set of quantization boundaries, for hue and/or saturation, as a set of intervals with each interval being represented as an integer times the basic quantization interval ω, which may be a predetermined value or a value that may be included in dynamic color metadata 120 but specified only one time. Because an integer may be represented with fewer bits than a fixed-point representation of a floating-point value, a set of quantization boundaries may be specified as a set of integers representing the quantization intervals.

For purposes of illustration, consider the case where k is the bit depth of the integer representations for each interval, and the fixed-point representation of ω requires q bits. In this example, the integer representations of quantization intervals will require k×N bits. In total, q+k×N bits are needed to specify a set of quantization boundaries. Since k<<q, q+k×N requires less storage than representing quantization boundaries as q×N.

As an illustrative and nonlimiting example, if 16 bits are used to specify the normalized quantization boundaries (q=16) and the number of quantization levels is 32 (N=32), the number of bits required to represent the quantization boundaries would be 16×32=512 bits. Using the storage techniques described hereinabove with 5 bits to represent the quantization intervals (ω=5), the bit budget for storing the same quantization boundaries requires 16+5×32=176 bits. This saves approximately 66% of the bit budget requiring less storage. Even more storage may be saved for cases that utilize higher precision boundaries (e.g., where q is larger than 16).

A receiving device such as receiving device 108 or image processing hardware included therein may rebuild the quantization boundaries from the quantization boundary information using Expression 4 below.

$${B}_{i} = {\sum }_{j = 1}^{i} ω \times {v}_{j} \qquad ( 4 )$$

Within Expression 4, i and j are the quantization interval indices and v is the integer representation of a quantization interval ω.

Turning to storing the 2D histogram (e.g., each discrete version for each segment), in some example implementations, the 2D histograms may be directly stored with a given bit depth. The bit depth may not be too low in order to support or maintain sufficient computation precision. For purposes of illustration, let Nₕ and Nₛ be the number of quantization levels of hue and saturation, respectively, and O be the bit depth of the distribution data. In some cases, Nₕ×Nₛ×O bits may be needed. For example, if dynamic color metadata 120 needs 8 quantization levels of hue, 16 quantization levels of saturation, and 16 bits data precision, each 2D hue-saturation histogram may require 8×16×16=2048 bits for storage of one 2D hue-saturation histogram for a single segment.

In one or more embodiments, because the 2D hue-saturation histograms are generally used as processing guidance for image processing hardware in receiving devices, such high precision may not be required. Accordingly, some precision of the 2D hue-saturation histograms may be sacrificed by quantizing the 2D histograms to reduce the storage required and save more bit budget.

For example, let l be the required bit depth of each of a plurality of uniform quantization levels in quantizing each 2D histogram. In that case, the quantization interval may be computed using Expression 5 below.

$$μ = \frac{max ( {p}_{ij} , i ∈ [ 0 , {N}_{h} ) , j ∈ [ 0 , {N}_{s} ) )}{{2}^{l}} \qquad ( 5 )$$

In Expression 5, pᵢⱼ is data in the 2D histogram (the i-th hue and the j-th saturation). In some cases, within the uniform quantization interval μ for the 2D histogram, pᵢⱼ can be represented as an integer tᵢⱼ, where

$${t}_{ij} = ⌊ \frac{{p}_{ij}}{μ} ⌋ .$$

In that case, the total bit budget for storing the 2D histogram becomes Nₕ×Nₛ×l. When l<<O, even less storage is required with this formulation. With the example above, using 32 levels of quantization such that l=5, only 8×16×5=640 bits of storage are required in comparison with the original 2048 bits required using conventional storage techniques. This saves approximately 69% of the original storage requirement. With the above quantization-based representation, a discrete 2D histogram may be saved with integer representation requiring Nₕ×Nₛ×l bits. The quantization interval of the 2D histograms may be saved as μ with O bits.

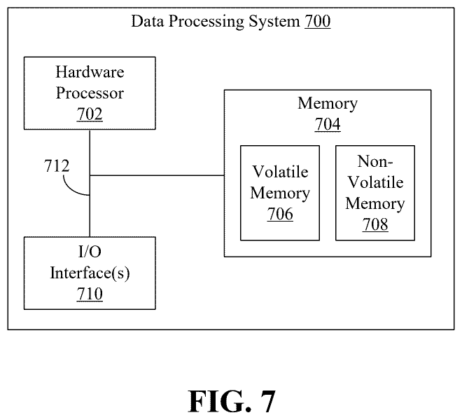

FIG. 7 illustrates an example of a data processing system 700. As used herein, “data processing system” refers to one or more hardware systems capable of processing data. A computer system is an example of a data processing system. Each hardware system may include one or more hardware processors and memory. Data processing system 700 is an example of a computer system that may be used to perform the operations described in connection with content creation environment 102 of FIG. 1. In other examples, data processing system 700 may represent image processing circuitry of receiving device 108.

Data processing system 700 includes a hardware processor 702. Hardware processor 702 may be implemented as one or more hardware processors. Hardware processor 702 may be implemented as one or more circuits capable of executing computer-readable program instructions (program instructions). The circuit(s) may comprise integrated circuits (ICs) or may be embedded within an IC. In one or more examples, hardware processor 702 may be embodied as a central processing unit (CPU). Hardware processor 702 may include one or more cores, for example, where each core is capable of executing computer-readable program instructions. Hardware processor 702 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like.

In one or more other examples, hardware processor 702 may be implemented as, or include, any of the various examples of hardware, e.g., image processing hardware and/or color-related image processing hardware described herein. Such hardware, e.g., hardware accelerators, may be included in lieu of a CPU or included with a CPU such that both are capable of operating cooperatively.

Data processing system 700 can include memory 704. Memory 704 may be embodied as one or more computer-readable storage mediums. Memory 704 may include a volatile memory 706 and a non-volatile memory 708. Volatile memory 706 may be embodied as random-access memory (RAM) and may include cache memory. Volatile memory 706 may be referred to as “runtime memory.” Non-volatile memory 708 may include a non-volatile magnetic medium and/or a solid-state medium (typically called a “hard drive”). Non-volatile memory 708 also may include one or more disk drives capable of reading from and writing to various types of removable, non-volatile mediums such as a removable, non-volatile magnetic disk (e.g., a “floppy disk”) and/or a removable, non-volatile optical disk such as a CD-ROM, DVD-ROM or other optical media.

Memory 704 is capable of storing program instructions and/or data such that hardware processor 702 is capable of executing the program instructions to perform one or more operations as described within this disclosure. For example, the program instructions can include an operating system, one or more application programs, other program code, and program data. In some examples, memory 704 may store program code and/or data to implement metadata extractor 114 encoder 116, decoder 126, tone-mapping module 128, and/or color enhancement module 130 depending on the particular device data processing system 700 represents. Hardware processor 702, in executing the computer-readable program instructions, is capable of performing the various operations described herein that are attributable to a computer.

Data processing system 700 may include one or more Input/Output (I/O) interfaces 710. I/O interface(s) 710 allow data processing system 700 to communicate with one or more external devices and/or communicate over one or more networks such as a local area network (LAN), a wide area network (WAN), and/or a public network (e.g., the Internet). Examples of I/O interfaces 710 may include, but are not limited to, network cards, modems, network adapters (wired and/or wireless), hardware controllers, etc. Examples of external devices also may include devices that allow a user to interact with data processing system 700 (e.g., a display such as professional display 106 and/or panel 132, a keyboard, and/or a pointing device) and/or other devices such as an accelerator card.

Bus 712 represents one or more of any of a variety of communication bus structures. By way of example, and not limitation, bus 712 may be implemented as a Peripheral Component Interconnect Express (PCIe) bus. Bus 712 couples to each of hardware processor 702, memory 704, and I/O interface(s) 710 through respective interface circuitry thereby allowing the devices to communicate. Bus 712 may represent a plurality of buses that may be interconnected and/or hierarchically organized.

Data processing system 700 is only one example implementation. Data processing system 700 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices. In other examples, data processing system 700 may represent any of a variety of receiving devices as described herein.

The example of FIG. 7 is not intended to suggest any limitation as to the scope of use or functionality of example implementations described herein. Data processing system 700 is an example of computer hardware that is capable of performing the various operations described within this disclosure. In this regard, data processing system 700 may include fewer components than shown or additional components not illustrated in FIG. 7 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage mediums. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a Digital Signal Processor (DSP), a Graphics Processing Unit (GPU), and a controller.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or two or more, e.g., a plurality, of such mediums) having computer readable program instructions thereon for causing a processor to carry out aspects of the present disclosed technology. Within this disclosure, the term “program code” is used interchangeably with the terms “computer readable program instructions” and “program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and/or computer program products according to various aspects of the inventive arrangements. In this regard, each block in the flowcharts or block diagrams may represent executable program instructions (e.g., a module, segment, or portion of such instructions), hardware/circuitry (e.g., an IC device and/or a circuit block or subsystem within an IC device including special-purpose hardware/circuitry), and/or a combination thereof for implementing the specified operations.

In some alternative implementations, the operations noted in the blocks may occur out of the order noted in the figures. For example, two blocks shown in succession may be performed/executed substantially concurrently, or the blocks may sometimes be performed/executed in the reverse order, depending upon the functionality involved.

The corresponding structures, materials, acts, and equivalents of all means or step plus function elements that may be found in the claims below are intended to include any structure, material, or act for performing the function in combination with other claimed elements as specifically claimed.

The description of the disclosed technology provided herein is for purposes of illustration and is not intended to be exhaustive or limited to the form and/or examples disclosed. The terminology used herein was chosen to explain the principles of the disclosed technology, the practical application or technical improvement over technologies found in the marketplace, and/or to enable others of ordinary skill in the art to understand the disclosed technology. Modifications and variations may be apparent to those of ordinary skill in the art without departing from the scope and spirit of the technology described herein. Accordingly, reference should be made to the following claims, rather than to the foregoing disclosure, as indicating the scope of such features and implementations.

What is claimed is:

1. A method, comprising:
separating chroma data from luma data of high-dynamic range (HDR) content that includes a plurality of segments; and
generating, from the chroma data, dynamic color metadata for each segment of the plurality of segments of the HDR content;
wherein the dynamic color metadata specifies hue and saturation data for the HDR content on a per segment basis.

2. The method of claim 1, further comprising:
encoding the dynamic color metadata with the HDR content.

3. The method of claim 1, wherein the dynamic color metadata includes quantization boundaries for hue and saturation.

4. The method of claim 1, wherein the dynamic color metadata for each segment is adapted to chroma information of the segment.

5. The method of claim 4, wherein the generating the dynamic color metadata for each segment comprises:
quantizing hue data for the segment into a predetermined number N of hue quantization levels; and
quantizing saturation data for the segment into a predetermined number M of saturation quantization levels.

6. The method of claim 5, wherein at least one of the N hue quantization levels or the M saturation quantization levels has non-linear boundaries.

7. The method of claim 5, wherein at least one of the N hue quantization levels or the M saturation quantization levels has linear boundaries.

8. The method of claim 5, further comprising:
for each segment, generating the hue and saturation data as an N×M matrix specifying a 2D histogram for the segment.

9. The method of claim 1, wherein the dynamic metadata specifies a hue-saturation joint distribution for each segment.

10. The method of claim 1, wherein a marginal distribution of hue and a marginal distribution of saturation each is derivable from the dynamic color metadata for each segment.

11. An apparatus, comprising:
a hardware processor capable of executing operations including:
separating chroma data from luma data of high-dynamic range (HDR) content that includes a plurality of segments; and
generating, from the chroma data, dynamic color metadata for each segment of the plurality of segments of the HDR content;
wherein the dynamic color metadata specifies hue and saturation data for the HDR content on a per segment basis.

12. The apparatus of claim 11, wherein the processor is capable of executing operations including:
encoding the dynamic color metadata with the HDR content.

13. The apparatus of claim 11, wherein the dynamic color metadata includes quantization boundaries for hue and saturation.

14. The apparatus of claim 11, wherein the generating the color metadata for each segment comprises:
quantizing hue data for the segment into a predetermined number N of hue quantization levels; and
quantizing saturation data for the segment into a predetermined number M of saturation quantization levels.

15. The apparatus of claim 14, wherein the processor is capable of executing operations including:
for each segment, generating the hue and saturation data as an N×M matrix specifying a 2D histogram for the segment.

16. The apparatus of claim 15, wherein at least one of the N hue quantization levels or the M saturation quantization levels has non-linear boundaries.

17. The apparatus of claim 15, wherein at least one of the N hue quantization levels or the M saturation quantization levels has linear boundaries.

18. A method, comprising:
receiving high-dynamic range (HDR) content having dynamic color metadata encoded therewith for each segment of a plurality of segments of the HDR content;
extracting the dynamic color metadata for the plurality of segments, wherein the dynamic color metadata specifies hue and saturation data for the HDR content on a per segment basis; and
adjusting at least one of hue or saturation of pixels of one or more frames of one or more of the plurality of segments of the HDR content based on the color metadata as extracted.

19. The method of claim 18, wherein the hue and saturation data for each segment includes an N×M matrix specifying a 2D histogram for the segment with N different hue quantization levels and M different saturation quantization levels.

20. The method of claim 18, wherein the adjusting at least one of hue or saturation of pixels of one or more frames comprises at least one of:
deriving a marginal distribution of hue from the color metadata and adjusting the hue of the one or more frames based on the marginal distribution of hue; or
deriving a marginal distribution of saturation from the color metadata and adjusting the saturation of the one or more frames based on the marginal distribution of saturation.
